(19) United States
(12) Patent Application Publication
(10) Pub. No.: US 2009/0314899 A1
(43) Pub. Date: Dec. 24, 2009

(54) STRUCTURAL ELEMENT OF AN AIRCRAFT

(75) Inventors: Alain Porte, Colomiers (FR); Bruno Medda, Tournefeuille (FR)

Correspondence Address: YOUNG & THOMPSON, 209 Madison Street, Suite 500, Alexandria, VA, 22314, US

(73) Assignee: AIRBUS FRANCE, SOCIETE PAR ACTIONS SIMPLIFIEE, TOULOUSE (FR)

(21) Appl. No.: 12/376,143

(22) PCT Filed: Jul. 30, 2007
(86) PCT No.: PCT/FR07/51751

§ 371 Date: Feb. 3, 2009

(30) Foreign Application Priority Data
Aug. 4, 2006 (FR) 0653291

(51) Int. Cl. B64D 33/02

(52) U.S. Cl. 244/53 B

(57) ABSTRACT

A rear frame of an air intake of a nacelle of an aircraft, is made in part of composite material that is based on a fiber-reinforced geopolymer resin and includes at least one part (56) that encompasses an orifice that is provided for the passage of a defrosting system that is made of composite material that is based on a fiber-reinforced geopolymer resin and at least one other metal part (58).

This invention relates to a structural element of an aircraft that can be subjected to high temperatures, such as in particular a rear frame of an aircraft nacelle.

An aircraft comprises structural elements that ensure in particular the absorption or the transfer of forces between different points of said structure. These elements make it possible in particular to support the outer shell of the aircraft that can be in contact with the air, and they impart a certain rigidity to it.

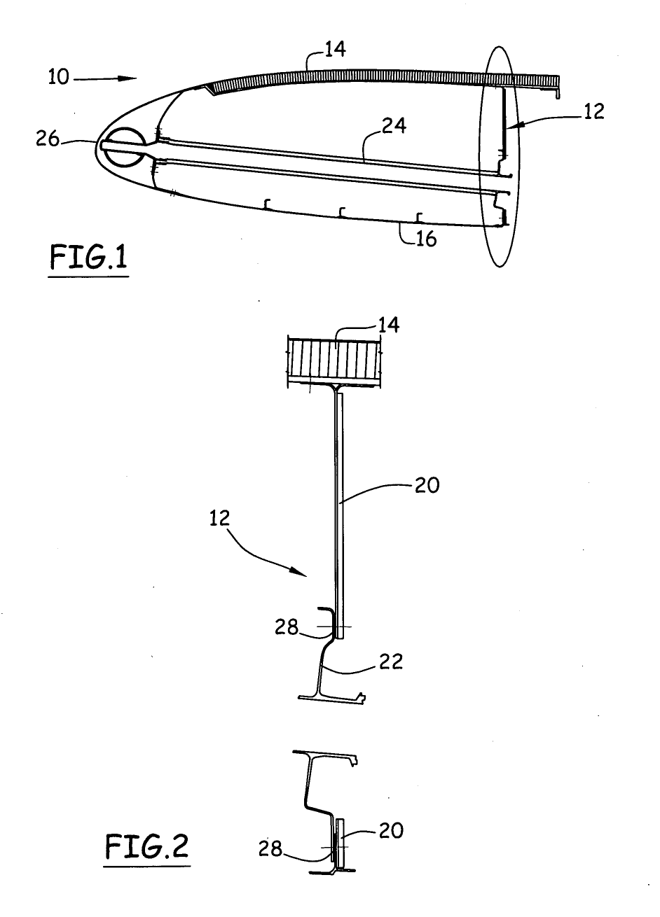

FIG. 1 shows a structural element that is provided at an aircraft air intake 10 that is arranged at the front of a nacelle in which a power plant is integrated, whereby said structural element is referred to as a rear frame 12 and connects the skin 14 that is arranged on the inside of the nacelle and the skin 16 that is arranged on the outside of the nacelle. This rear frame 10 ensures the absorption of flexural forces, rotational forces, etc., that impinge on the air intake, such as, for example, the weight of the air intake, the forces induced by the aerodynamic flow.

Taking into consideration the importance of the part of the fuel in the operating costs of an aircraft, the manufacturers tend to reduce the aircraft weight so as to reduce the aircraft's consumption, in particular by using composite materials to produce elements of the structure of an aircraft.

These composite materials consist of fibers, in particular carbon, graphite, basalt, aramid or glass, for example, woven in a matrix made of organic resin such as, for example, an epoxy, thermoplastic or thermosetting resin. The fibers can come in the form of fabric or non-woven sheets of fabric, as appropriate.

To be able to be used subsequently, these fibers are generally coated. Actually, during their production, the surface condition of these fibers is degraded, which impairs the adhesion of the organic resins. In addition, the manipulation of fibers in the raw state, during a weaving operation, for example, is tricky because fibrils become detached from the main bundle. Also, the dry fibers are treated to restore the surface condition and then coated by an organic resin that promotes chemical adhesion for subsequent impregnation. This coating is referred to as finish. The finished commercialized fibers are smooth and ready for use.

Industrial techniques have been developed for the implementation of the finished fibers and epoxy resins. These techniques are controlled and make it possible to obtain production costs of parts that are compatible with those of the equivalent metal parts.

Furthermore, the composite-material parts offer mechanical characteristics that are at least equal to those of the metal parts and are clearly lighter than the latter.

However, the use of composite materials for producing parts of the structure may prove problematic in some cases, in particular when said parts are placed in zones that can be subjected to high temperatures, for example of more than 500° C. This is in particular the case of the rear frame of the air intake. However, at such temperatures, the parts that are made of composite material that is based on organic resin lose their mechanical and structural characteristics, which is not acceptable for such elements.

A first solution consists in not using composite materials for producing these elements but rather titanium. Even if the parts retain their mechanical and structural characteristics at high temperatures, this solution does not make it possible to reduce the weight of the aircraft and leads to higher production and operating costs.

Another solution consists in using composite materials of the prior art and in covering the surfaces that can be subjected to high temperatures by heat insulation, also referred to as a fire shield. According to the example that is illustrated in FIG. 2, the rear frame 12 is made of composite material and covered by fire shields 20 to protect the faces made of composite material that can be subjected to high temperatures.

According to a first variant, the fire shield can consist of a glass wool or mineral wool inserted between two shiny metal foils. According to another variant, the fire shield can consist of a silicone layer.

In the case of the rear frame, the latter also comprises a flange 22 for a tube 24 that is provided for the defrosting system of the lip 26 of the air intake that uses the air drawn off at the engine at high temperature. To protect the rear frame that is made of composite material, it is necessary to provide insulation 28 between the flange and said frame.

Consequently, the use of a composite material according to the prior art is not satisfactory, because it complicates the production of the structural element because of the addition of insulating elements such as fire shields, and the increase in weight associated with the use of composite material is reduced almost to zero by the presence of the fire shields.

Also, this invention aims at remedying the drawbacks of the prior art by proposing a rear frame of an air intake of an aircraft nacelle that is lighter and that can retain its mechanical and structural characteristics at high temperatures.

For this purpose, the invention has as its object a rear frame of an air intake of a nacelle of an aircraft, characterized in that it is produced in part from a composite material that is based on a fiber-reinforced geopolymer resin, and it comprises at least one part that encompasses an orifice that is provided for the passage of a defrosting system that is made of composite material that is based on a fiber-reinforced geopolymer resin and at least one other metal part.

Other characteristics and advantages will emerge from the following description of the invention, a description that is provided only by way of example, taking into account the accompanying drawings, in which:

FIG. 1 is a longitudinal cutaway of an air intake of an aircraft nacelle that comprises a structural element that is referred to as a rear frame according to the prior art,

FIG. 2 is a cutaway that illustrates in detail a rear frame according to the prior art,

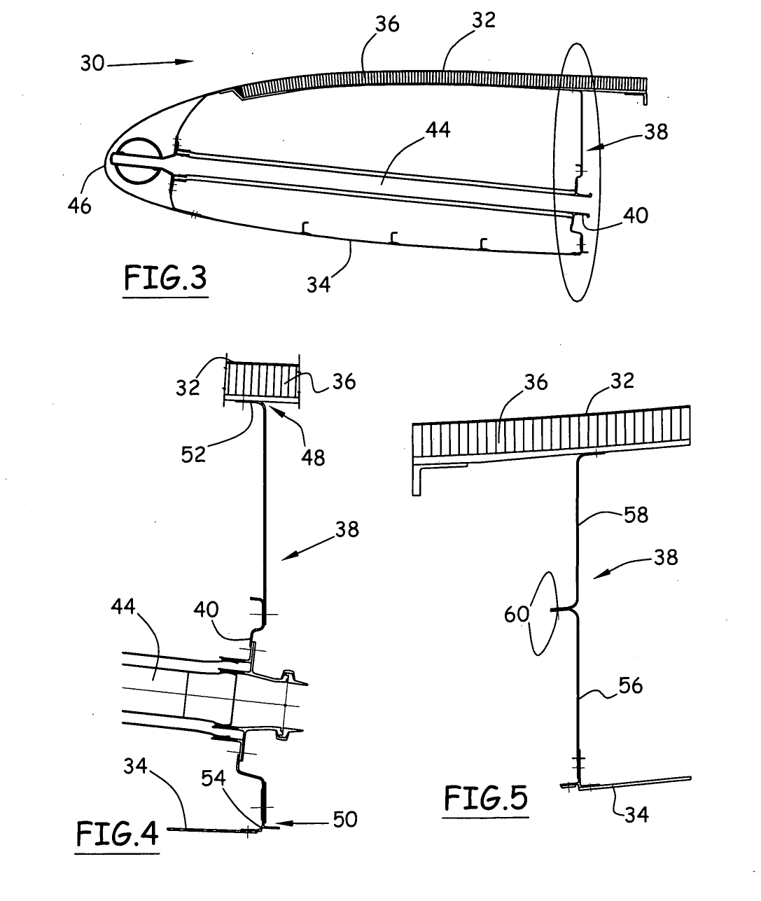

FIG. 3 is a longitudinal cutaway of an air intake of an aircraft nacelle that comprises a structural element that is referred to as a rear frame according to the invention,

FIG. 4 is a cutaway that illustrates in detail a rear frame according to a first variant of the invention, and

FIG. 5 is a cutaway that illustrates in detail a rear frame according to another variant of the invention.

At 30, FIG. 3 shows an air intake of a nacelle of an aircraft. This air intake comprises a so-called internal skin 32 that can be in contact with the aerodynamic flows that flow on the inside of the nacelle and a so-called external skin 34 that can be in contact with the aerodynamic flows that flow on the outside of the nacelle.

The internal skin 32 can comprise an acoustic panel or coating 36. The internal and external skins are not presented in more detail because they are known to one skilled in the art.

The air intake 30 comprises a structural element, referred to as a rear frame 38, which connects the internal skin 32 and the external skin 34 and ensures the absorption of flexural forces, rotational forces, etc., that impinge on the air intake, such as, for example, the weight of the air intake, the forces induced by the aerodynamic flow.

This rear frame 38 can comprise an opening at which is provided a flange 40 that supports a tube 44 that is provided for a defrosting system of the lip 46 of the air intake 30 that uses the air drawn off at the engine at high temperature.

According to the invention, the rear frame 38 is produced at least in part from composite material that comprises a fiber-reinforced geopolymer resin.

To obtain a material that is able to retain its mechanical strength at high temperature, a sialate-type geopolymer resin (xSiO₂, AlO₂), in which x is between or equal to 1.75 and 50, is used. Advantageously, the commercialized resin is used under the name MEYEB by the Cordi-Geopolymer Company.

Geopolymer resin is defined as a geopolymer resin or a mixture of geopolymer resins.

According to the applications, the fibers can have different sections and be produced from different materials, such as, for example, carbon, graphite, basalt, aramid or glass.

The fibers can be in the form of a woven material, a non-woven material, or a sheet of fabric.

To be able to be used subsequently, these fibers are generally coated. Actually, during their production, the surface condition of these fibers is degraded, which impairs the adhesion of the organic resins. In addition, the manipulation of fibers in the raw state, during a weaving operation for example, is tricky because fibrils become detached from the main bundle. Also, the dry fibers are treated to restore the surface condition and then are coated by an organic resin that promotes chemical adhesion for subsequent impregnation. This coating is referred to as finish. The finished commercialized fibers are smooth and ready for use. The amount of finishing is relatively low relative to the fiber and represents only on the order of 1% by mass of the finished fiber. Furthermore, the nature of the organic resin that is used for the finishing can vary from one manufacturer to the next.

To promote the adhesion of the geopolymer resin matrix to the fibers, it is necessary to remove the finish at least partially, whereby the organic resins and the geopolymer resins are immiscible.

The removal of the finish by a heat or chemical treatment makes possible the use of extensively commercialized fabrics.

According to one embodiment, the removal of the finish is carried out using a heat treatment that consists in heating the fibers up to the heat degradation temperature of the resin so that the latter no longer adheres to the fibers. Advantageously, the heat treatment is carried out under inert atmosphere.

This treatment makes it possible to treat the majority of the commercialized fibers with a possible adjustment of the temperature and/or the temperature cycle to which the finished fibers are subjected. It makes possible a relatively fast treatment on the order of several minutes.

Whereby the heat degradation temperatures of the resins that are used for the finish are very close to the oxidation temperature of the carbon fibers, it is advisable to determine the temperature and/or the temperature cycle to which the fibers are subjected. Actually, too high a level of degradation of the fibers would lead to greatly reducing the characteristics of the product that is obtained.

In general, the end of the removal period of the finish corresponds to the beginning of the degradation period of the fibers.

A good compromise for obtaining satisfactory adhesion and limited degradation of fibers consists in removing between 50% and 90% of the finish.

To determine the heating temperature, a test is carried out on a sample. Using a thermogravimetric analysis (TGA) that may or may not be associated with a mass spectrography, it is possible to identify the compound that is used for the finish and to determine the beginning and end removal temperatures as well as the subtracted mass.

The heat treatment then consists in heating the product under inert atmosphere by taking care to keep the mean temperature of the furnace in the range determined during the thermogravimetric analysis. Final monitoring of the mass loss makes it possible to validate the process.

According to another operating mode, the removal of the finish can be done by using a chemical treatment, in particular by using a solvent.

First of all, it is necessary to identify the compound that is used for the finish so as to select the solvent. This identification can be conducted by a thermogravimetric analysis. The chemical method is relatively simple to use and requires at least one solvent bath, such as methylene chloride, for example. The treatment period is determined based on, in particular, the compound that is used for the finish.

To reduce the treatment period, a good compromise for obtaining satisfactory adhesion and a limited treatment period consists in removing between 50% and 90% of the finish.

According to another characteristic of the invention, to improve the impregnation of the fibers, an addition of water in the resin, on the order of 3 to 7% by volume to improve the fluidity of said resin and to obtain a homogenization of the migration of said resin in the fibers, is carried out. This addition of water is more than the amount of water recommended by the resin manufacturer.

The rear frame 38 that is made at least in part with a geopolymer resin-based composite material withstands high temperatures and retains its structural and mechanical characteristics. This solution makes possible an actual increase in weight because it requires neither fire shield for protecting the faces of the rear frame 38 from heat, nor insulation inserted between the flange 40 and said frame.

The rear frame 38 has an annular shape that extends from the internal skin 32 up to the external skin 34 with means 48 for connecting to the internal skin and means 50 for connecting to the external skin. To allow the passage of the defrosting system of the lip 46, an orifice is made in this annular shape to accommodate a flange 40.

According to one embodiment, the connecting means 48 come in the form of at least one curved edge 52 of the rear frame 38, flattened against the internal skin and secured to the latter by any suitable means.

According to one embodiment, the connecting means 50 have a T-shape 54 whose head is secured by any suitable means to the external skin and whose base is secured by any suitable means to the frame.

The connecting means 48 and 50 are not limited to these embodiments. Other solutions are conceivable.

The rear frame 38 is made in part from a composite material that is based on a fiber-reinforced geopolymer resin, whereby at least the part encompassing an orifice that is provided for the passage of a defrosting system is made of composite material that is based on a fiber-reinforced geopolymer resin and at least one other part is metal in order to be able to deform and to absorb energy in the case of an impact. As illustrated in FIG. 5, the rear frame comprises two concentric parts, a first annular part 56 that is made of a geopolymer resin-based composite material that is in contact with the external skin 34 and a second metal annular part 58 that is in contact with the internal skin 32, whereby the two parts 56 and 58 are connected by any suitable means, in particular curved edges 60 that are provided at each of the parts, which are made integral. This solution is preferred when the nacelle comprises a large-diameter fan and when the energy of a blade during a failure is high. The metal part 58 of the rear frame can absorb a portion of this energy by being deformed.

Of course, the invention obviously is not limited to the embodiment that is shown and described above, but indeed covers all of its variants.

1. Rear frame of an air intake of a nacelle of an aircraft, characterized in that it is made in part of composite material that is based on a fiber-reinforced geopolymer resin and comprises at least one part (56) that encompasses an orifice that is provided for the passage of a defrosting system that is made of a composite material that is based on a fiber-reinforced geopolymer resin and at least one other metal part (58).

2. Rear frame of an air intake of a nacelle of an aircraft according to claim 1, wherein it comprises two concentric parts, a first annular part (56) made of composite material that is based on a fiber-reinforced geopolymer resin that is in contact with the external skin (34) of the nacelle and a second annular metal part (58) that is in contact with the internal skin (32) of the nacelle.

3. Rear frame of an air intake of a nacelle of an aircraft according to claim 1, wherein it is made from a composite material that is based on fibers that are woven into a sialate-type geopolymer resin (xSiO₂, AlO₂), in which x is between or equal to 1.75 and 50.

4. Rear frame of an air intake of a nacelle of an aircraft according to claim 3, wherein the finish has been at least partially removed from the fibers prior to the impregnation with the geopolymer resin.

5. Rear frame of an air intake of a nacelle of an aircraft according to claim 2, wherein it is made from a composite material that is based on fibers that are woven into a sialate-type geopolymer resin (xSiO₂, AlO₂), in which x is between or equal to 1.75 and 50.
